(19) United States
(12) Patent Application Publication
(10) Pub. No.: US 2024/0399714 A1
(43) Pub. Date: Dec. 5, 2024

(54) METAMATERIAL AND LAMINATE

(71) Applicant: FUJIFILM Corporation, Tokyo (JP)

(72) Inventor: Yasuyuki SASADA, Kanagawa (JP)

(73) Assignee: FUJIFILM Corporation, Tokyo (JP)

(21) Appl. No.: 18/800,111

(22) Filed: Aug. 11, 2024

Related U.S. Application Data
(63) Continuation of application No. PCT/JP2023/003881, filed on Feb. 6, 2023.

(30) Foreign Application Priority Data
Feb. 28, 2022 (JP) 2022-030213

(51) Int. Cl. B32B 15/09; B32B 15/20; B32B 27/08; B32B 27/20; B32B 27/32; B32B 27/36

(52) U.S. Cl. CPC B32B 15/09; B32B 15/20; B32B 27/08; B32B 27/20; B32B 27/325; B32B 27/36; B32B 2255/10; B32B 2255/205; B32B 2307/202; B32B 2307/204; B32B 2307/51; B32B 2307/748

(57) ABSTRACT

Provided are a metamaterial including a base material including at least an elastic layer in which an elastic recovery rate at 25° C. is 80% or less and a pattern provided on a surface of the elastic layer, in which the pattern is composed of at least one of a conductive material or a material which transits from an insulator to a conductor; and a laminate.

### CROSS-REFERENCE TO RELATED APPLICATIONS

This application is a continuation application of International Application No. PCT/JP2023/003881, filed Feb. 6, 2023, the disclosure of which is incorporated herein by reference in its entirety. Further, this application claims priority from Japanese Patent Application No. 2022-030213, filed Feb. 28, 2022, the disclosure of which is incorporated herein by reference in its entirety.

### BACKGROUND OF THE INVENTION

### 1. Field of the Invention

The present disclosure relates to a metamaterial and a laminate.

### 2. Description of the Related Art

In recent years, it has been studied to apply a metamaterial including a base material and a pattern which is composed of a conductive material or the like and is provided on a surface of the base material to an optical element for electromagnetic waves having a frequency of 0.1 THz to 10 THz (wavelength: 30 μm to 3,000 μm) (hereinafter, also referred to as electromagnetic waves in a terahertz band).

For example, JP2021-114647A discloses a metamaterial including a metasurface base material and a pattern of a metal film, provided on a surface of the metasurface base material.

### SUMMARY OF THE INVENTION

Here, the above-described pattern included in the metamaterial disclosed in JP2021-114647A functions as a resonator with respect to the electromagnetic waves in a terahertz band. Since a portion that functions as the resonator with respect to the electromagnetic waves in a terahertz band is left up to a portion of approximately 0.5 μm in a thickness direction from a surface of the pattern, it is assumed that the thickness of the pattern is to be reduced from the viewpoint of cost reduction and the like in the future development.

The present inventor has found that, in a case where the thickness of the pattern is reduced, rigidity of the pattern is lowered, an internal stress is generated due to deformation of the base material caused by a change in temperature and humidity, and there is a risk of peeling of the pattern from the base material.

The present disclosure has been made based on the above-described findings, and an object to be achieved by an embodiment of the present disclosure is to provide a metamaterial and a laminate, which have excellent adhesiveness between a base material and a pattern.

Specific methods for achieving the object are as follows.
<1> A metamaterial comprising:
a base material including at least an elastic layer in which an elastic recovery rate at 25° C. is 80% or less; and
a pattern provided on a surface of the elastic layer,
in which the pattern is composed of at least one of a conductive material or a material which transits from an insulator to a conductor.
<2> The metamaterial according to <1>,
in which a thickness of the elastic layer is 7 μm to 15 μm.
<3> The metamaterial according to <1> or <2>,
in which the elastic layer contains a thermoplastic elastomer having a glass transition temperature of −70° C. to 25° C.
<4> The metamaterial according to any one of <1> to <3>,
in which a dielectric loss tangent of the base material is 0.01 or less.
<5> The metamaterial according to any one of <1> to <4>,
in which a thickness of the pattern is less than 5 μm.
<6> The metamaterial according to any one of <1> to <5>,
in which a ratio of a product of a thickness of the pattern and a storage elastic modulus of the pattern at 25° C. to a product of a thickness of the base material and a storage elastic modulus of the base material at 25° C. is less than 10.
<7> The metamaterial according to any one of <1> to <6>,
in which the pattern includes a plurality of structural bodies, and
the structural bodies are a split-ring resonator.
<8> The metamaterial according to any one of <1> to <7>,
in which the pattern is composed of the conductive material, and
the conductive material includes a metal.
<9> The metamaterial according to any one of <1> to <8>,
in which the elastic layer contains at least one selected from the group consisting of a fluorine-based polymer and a liquid crystal polymer.
<10> A laminate comprising:
the metamaterial according to any one of <1> to <9>; and
an organic film provided on a surface of the metamaterial on a pattern side.
<11> The laminate according to <10>,
in which a moisture permeability of the organic film in an environment of a temperature of 40° C. and a relative humidity of 90% is 3,000 g/(m²·24 hours) or less.
<12> The laminate according to <10> or <11>,
in which the organic film contains an ultraviolet absorber.

According to the embodiment of the present disclosure, it is possible to provide a metamaterial and a laminate, which have excellent adhesiveness between a base material and a pattern.

### BRIEF DESCRIPTION OF THE DRAWINGS

FIG. 1 is a perspective view showing an embodiment of a metamaterial according to the present disclosure.

FIG. 2 is a cross-sectional view taken along a line A-A of the metamaterial in FIG. 1.

FIG. 3 is a cross-sectional view showing an embodiment of the metamaterial according to the present disclosure.

### DESCRIPTION OF THE PREFERRED EMBODIMENTS

In the present disclosure, each component may contain a plurality of types of corresponding substances.

In the present disclosure, a term “layer” or “film” includes not only a case where the layer or the film is formed over the entire region but also a case where the layer or the film is formed only in part of the region.

In the present disclosure, the term “step” includes not only an independent step but also a step that cannot be clearly distinguished from other steps, as long as the intended purpose of the step is achieved.

In the present disclosure, the term “metamaterial” refers to a member which is composed of a conductive material or the like and has a pattern that functions as a resonator with respect to electromagnetic waves.

The metamaterial preferably has a pattern serving as a resonator with respect to electromagnetic waves having a frequency of 0.01 THz to 10 THz (wavelength: 30 μm to 30,000 μm), and more preferably has a pattern serving as a resonator with respect to electromagnetic waves having a frequency of 0.1 THz to 10 THz (wavelength: 30 μm to 3,000 μm).

In the present disclosure, the elastic recovery rate of the elastic layer is measured by the following nano-indentation method.

First, a cross-sectional sample of the base material is cut out using a microtome.

Next, using a nano-indenter, a load is applied to the elastic layer of the cross-sectional sample by pushing the indenter from a side surface direction, and then the indenter is returned to unload, thereby obtaining a load-displacement curve.

The elastic recovery rate is obtained from a ratio (V2/V1×100) of a maximum displacement amount V1 of the obtained curve and a difference V2 in displacement amount at which the load is 0 in a case where the indenter is returned from the maximum displacement amount.

In the actual measurement, the measurement mode is set to a single indentation measurement, the measurement temperature is set to 25° C., a Berkovich (pyramidal) type diamond indenter is used as the indenter, the indentation depth of the indenter with respect to the cross-sectional sample is set to 300 nm, the indentation speed of the indenter is set to 10 nm/sec, and the pulling-out speed of the indenter from the cross-sectional sample is set to 10 nm/sec.

As the nano-indenter, Triboindenter manufactured by Hysitron, Inc. or similar apparatus can be used.

In the present disclosure, the thermoplastic elastomer means a polymer having a glass transition temperature of 25° C. or lower.

In addition, in the present disclosure, the glass transition temperature of the thermoplastic elastomer is obtained from a differential scanning calorimetry (DSC) curve obtained by DSC, and more specifically, it is obtained by “Extrapolated glass transition onset temperature” described in the method of obtaining the glass of transition temperature of “Method of measuring transition temperature of plastic” of JIS K 7121 (1987).

In the present disclosure, a measurement of a storage elastic modulus of the base material at 25° C. is carried out under conditions of a temperature of 25° C. and a relative humidity of 50%, in conformity with the method described in JIS K 7127 (1999).

In a case of measuring the storage elastic modulus of the base material, a test piece having a size of 10 mm×150 mm is produced, and the storage elastic modulus of the test piece is measured.

In a case of measuring the storage elastic modulus of the pattern, the pattern formed on the surface of the base material is cut out to have a size of 5 mm×5 mm to produce a test piece, and the storage elastic modulus of the test piece is measured under the conditions of a temperature of 25° C. and a relative humidity of 50% using a scanning probe microscope.

In the present disclosure, a measurement of a moisture permeability is carried out under conditions of a temperature of 40° C., a relative humidity of 90%, and 24 hours of standing, in conformity with the method described in JIS Z 0208 (1976).

In the present disclosure, a weight-average molecular weight (Mw) is a molecular weight converted using polystyrene as a standard substance by performing detection with a gel permeation chromatography (GPC) analysis apparatus using TSKgel SuperHM-H (trade name, manufactured by Tosoh Corporation) column, a solvent of pentafluorophenol (PFP) and chloroform at a mass ratio of 1:2, and a differential refractometer, unless otherwise specified.

In the present disclosure, “(meth)acrylic” is a concept including both acrylic and methacrylic.

In the present disclosure, “solid content” means components forming a layer formed of a composition or the like, and in a case where the composition or the like contains a solvent (an organic solvent, water, or the like), it means all components excluding the solvent. In addition, a liquid component is also regarded as the solid content in a case where the component is a component which forms the layer.

In the present disclosure, in a case where an embodiment is described with reference to the drawing, the configuration of the embodiment is not limited to the configuration shown in the drawing. In addition, sizes of members in each drawing are conceptual, and a relative relationship between the sizes of the members is not limited thereto.

### [Metamaterial]

The metamaterial according to the present disclosure includes a base material including at least an elastic layer in which an elastic recovery rate at 25° C. is 80% or less and a pattern provided on a surface of the elastic layer, in which the pattern is composed of at least one of a conductive material or a material which transits from an insulator to a conductor.

The metamaterial according to the present disclosure has excellent adhesiveness between the base material and the pattern. The mechanism by which the above-described effect is exhibited is not clear, but is presumed as follows. In the metamaterial, the pattern is provided on the surface of the elastic layer having an elastic recovery rate of 80% or less at 25° C., and it is presumed that an internal stress generated in the pattern is relaxed, and the adhesiveness between the base material for a metamaterial and the pattern is improved.

### (Base Material)

The base material included in the metamaterial according to the present disclosure includes at least an elastic layer in which an elastic recovery rate at 25° C. is 80% or less. From the viewpoint of adhesiveness between the base material and the pattern and viewpoint of suppressing the occurrence of cracks in the pattern, the elastic recovery rate of the elastic layer is preferably 0.1% to 60% and more preferably 1% to 50%.

The base material may have a monolayer structure or a multilayer structure. In a case where the base material has a multilayer structure, the above-described elastic layer is provided on an outermost surface of the base material, which can be brought into contact with the pattern.

In addition, the base material may include two or more elastic layers.

### Elastic Layer

A material constituting the elastic layer is not particularly limited as long as the above-described elastic recovery rate is satisfied.

From the viewpoint of adhesiveness between the base material and the pattern and viewpoint of suppressing the occurrence of cracks in the pattern, it is preferable that the elastic layer contains a thermoplastic elastomer.

From the viewpoint of adhesiveness between the base material and the pattern and viewpoint of suppressing the occurrence of cracks in the pattern, the glass transition temperature of the thermoplastic elastomer is preferably −150° C. to 25° C., more preferably −150° C. to 5° C., and still more preferably −125° C. to 0° C.

The type of the thermoplastic elastomer is not particularly limited, and examples thereof include a polystyrene-based elastomer, an olefin-based elastomer, a polyvinyl chloride-based elastomer, a polyurethane-based elastomer, a polyester-based elastomer, and a polyamide-based elastomer.

Among the above, from the viewpoint of adhesiveness between the base material and the pattern and viewpoint of suppressing the occurrence of cracks in the pattern, the thermoplastic elastomer is preferably a styrene-based elastomer or an olefin-based elastomer, and more preferably a styrene-based elastomer.

The styrene-based elastomer is not particularly limited as long as it includes a constitutional unit derived from a styrene compound, and a known styrene-based elastomer in the related art can be used.

Examples of the styrene-based elastomer include a styrene-isobutylene-styrene copolymer, a styrene-ethylene-butylene-styrene copolymer, a styrene-propylene-styrene copolymer, and a methyl methacrylate-butadiene-styrene copolymer. In addition, at least a part of double bonds of the conjugated diene component in these styrene-based elastomers may be hydrogenated.

The olefin-based elastomer is not particularly limited as long as it includes a constitutional unit derived from an olefin compound, and a known olefin-based elastomer in the related art can be used.

As the olefin-based elastomer, a copolymer of α-olefins having 2 to 20 carbon atoms, such as ethylene, propylene, 1-butene, 1-hexene, and 4-methyl-pentene, is preferable; and examples thereof include an ethylene-propylene copolymer and an ethylene-propylene-diene copolymer.

In addition, the olefin-based elastomer may be a copolymer of a non-conjugated diene having 2 to 20 carbon atoms, such as dicyclopentadiene, 1,4-hexadiene, butadiene, and isoprene, and an α-olefin.

A weight-average molecular weight of the thermoplastic elastomer is not particularly limited, but is preferably 5,000 to 500,000, more preferably 10,000 to 300,000, and still more preferably 50,000 to 200,000.

From the viewpoint of adhesiveness between the base material and the pattern and viewpoint of suppressing the occurrence of cracks in the pattern, a content of the thermoplastic elastomer with respect to the total mass of the elastic layer is preferably 30% by mass or more, more preferably 50% by mass or more, still more preferably 60% by mass or more, particularly preferably 70% by mass or more, and most preferably 80% by mass or more.

From the viewpoint of suppressing the occurrence of cracks in the pattern, the content of the thermoplastic elastomer with respect to the total mass of the elastic layer is preferably 98% by mass or less, more preferably 95% by mass or less, and still more preferably 90% by mass or less.

The elastic layer may contain a resin. In the present disclosure, the resin does not include the above-described thermoplastic elastomer.

Examples of the resin which can be contained in the elastic layer include thermoplastic resins such as a liquid crystal polymer, a fluorine-based polymer, a polymerized substance of a compound which has a cyclic aliphatic hydrocarbon group and a group having an ethylenically unsaturated bond, polyether ether ketone, polyolefin, polyamide, polyester, polyphenylene sulfide, aromatic polyether ketone, polycarbonate, polyarylate, polyethersulfone, polyphenylene ether and a modified product thereof, and polyetherimide; and thermosetting resins such as a phenol resin, an epoxy resin, a polyimide resin, and a cyanate resin.

Among these, from the viewpoint of dielectric loss tangent, adhesiveness with the pattern, and heat resistance, at least one selected from the group consisting of a liquid crystal polymer, a fluorine-based polymer, a polymerized substance of a compound which has a cyclic aliphatic hydrocarbon group and a group having an ethylenically unsaturated bond, polyphenylene ether, aromatic polyether ketone, and an epoxy resin is preferable, and at least one selected from the group consisting of a liquid crystal polymer and a fluorine-based polymer is more preferable.

From the viewpoint of adhesiveness with the pattern and mechanical strength, a liquid crystal polymer is preferable, and from the viewpoint of heat resistance and dielectric loss tangent, a polymerized substance of a compound which has a cyclic aliphatic hydrocarbon group and a group having an ethylenically unsaturated bond, a polyarylate, a polyethersulfone, or a fluorine-based polymer is preferable.

The liquid crystal polymer may be a thermotropic liquid crystal polymer which exhibits liquid crystallinity in a molten state, or may be a lyotropic liquid crystal polymer which exhibits liquid crystallinity in a solution state. Further, in a case where the liquid crystal polymer is a thermotropic liquid crystal polymer, the liquid crystal polymer is preferably a liquid crystal polymer which is molten at a temperature of 450° C. or lower.

Examples of the liquid crystal polymer include a liquid crystal polyester, a liquid crystal polyester amide in which an amide bond is introduced into the liquid crystal polyester, a liquid crystal polyester ether in which an ether bond is introduced into the liquid crystal polyester, and a liquid crystal polyester carbonate in which a carbonate bond is introduced into the liquid crystal polyester.

In addition, as the liquid crystal polymer, from the viewpoint of liquid crystallinity and thermal expansion coefficient, a polymer having an aromatic ring is preferable, and an aromatic polyester or an aromatic polyester amide is more preferable.

Further, the liquid crystal polymer may be a polymer in which an imide bond, a carbodiimide bond, a bond derived from an isocyanate, such as an isocyanurate bond, or the like is further introduced into the aromatic polyester or the aromatic polyester amide.

Further, it is preferable that the liquid crystal polymer is a wholly aromatic liquid crystal polymer formed of only an aromatic compound as a raw material monomer.

Examples of the liquid crystal polymer include the following liquid crystal polymers.
1) a liquid crystal polymer obtained by polycondensing (i) an aromatic hydroxycarboxylic acid, (ii) an aromatic dicarboxylic acid, and (iii) at least one compound selected from the group consisting of an aromatic diol, an aromatic hydroxyamine, and an aromatic diamine;
2) a liquid crystal polymer obtained by polycondensing a plurality of types of aromatic hydroxycarboxylic acids;
3) a liquid crystal polymer obtained by polycondensing (i) an aromatic dicarboxylic acid and (ii) at least one compound selected from the group consisting of an aromatic diol, an aromatic hydroxyamine, and an aromatic diamine;
4) a liquid crystal polymer obtained by polycondensing (i) polyester such as polyethylene terephthalate and (ii) an aromatic hydroxycarboxylic acid.

Here, the aromatic hydroxycarboxylic acid, the aromatic dicarboxylic acid, the aromatic diol, the aromatic hydroxyamine, and the aromatic diamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.

The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.

The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.

Examples of a polymerizable derivative of a compound having a hydroxy group, such as an aromatic hydroxycarboxylic acid, an aromatic diol, and an aromatic hydroxyamine, include a derivative (acylated product) obtained by acylating a hydroxy group and converting the acylated group into an acyloxy group.

For example, the aromatic hydroxycarboxylic acid, the aromatic diol, and the aromatic hydroxyamine can be each replaced with an acylated product by acylating a hydroxy group and converting the acylated group into an acyloxy group.

Examples of a polymerizable derivative of a compound having an amino group, such as an aromatic hydroxyamine or an aromatic diamine, include a derivative (acylated product) obtained by acylating an amino group and converting the acylated group to an acylamino group.

For example, the aromatic hydroxyamine and the aromatic diamine can be each replaced with an acylated product by acylating an amino group and converting the acylated group into an acylamino group.

From the viewpoint of liquid crystallinity, dielectric loss tangent, and adhesiveness with the pattern, the liquid crystal polymer preferably has a constitutional unit represented by any of Formulae (1) to (3) (hereinafter, a constitutional unit represented by Formula (1) or the like may be referred to as a constitutional unit (1) or the like), more preferably has a constitutional unit represented by Formula (1), and particularly preferably has a constitutional unit represented by Formula (1), a constitutional unit represented by Formula (2), and a constitutional unit represented by Formula (3).

—O—Ar¹—CO— Formula (1)

—CO—Ar²—CO— Formula (2)

—X—Ar³—Y— Formula (3)
in Formulae (1) to (3), Ar¹ represents a phenylene group, a naphthylene group, or a biphenylylene group, Ar² and Ar³ each independently represent a phenylene group, a naphthylene group, a biphenylylene group, or a group represented by Formula (4), X and Y each independently represent an oxygen atom or an imino group, and hydrogen atoms in Ar¹ to Ar³ may be each independently substituted with a halogen atom, an alkyl group, or an aryl group,

—Ar⁴—Z—Ar⁵— Formula (4)
in Formula (4), Ar⁴ and Ar⁵ each independently represent a phenylene group or a naphthylene group, and Z represents an oxygen atom, a sulfur atom, a carbonyl group, a sulfonyl group, or an alkylene group.

Examples of the halogen atom include a fluorine atom, a chlorine atom, a bromine atom, and an iodine atom.

Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group. The number of carbon atoms in the alkyl group is preferably 1 to 10.

Examples of the aryl group include a phenyl group, an o-tolyl group, an m-tolyl group, a p-tolyl group, a 1-naphthyl group, and a 2-naphthyl group. The number of carbon atoms in the aryl group is preferably 6 to 20.

In a case where the hydrogen atom is substituted with any of these groups, the number of each of substitutions in Ar¹, Ar², and Ar³ independently is preferably 2 or less and more preferably 1.

Examples of the alkylene group include a methylene group, a 1,1-ethanediyl group, a 1-methyl-1,1-ethanediyl group, a 1,1-butanediyl group, and a 2-ethyl-1,1-hexanediyl group. The number of carbon atoms in the alkylene group is preferably 1 to 10.

The constitutional unit (1) is a constitutional unit derived from an aromatic hydroxycarboxylic acid.

As the constitutional unit (1), an aspect in which Ar¹ represents a p-phenylene group (constitutional unit derived from p-hydroxybenzoic acid), an aspect in which Ar¹ represents a 2,6-naphthylene group (constitutional unit derived from 6-hydroxy-2-naphthoic acid), or an aspect in which Ar¹ represents a 4,4′-biphenylylene group (constitutional unit derived from 4′-hydroxy-4-biphenylcarboxylic acid) is preferable.

The constitutional unit (2) is a constitutional unit derived from an aromatic dicarboxylic acid.

As the constitutional unit (2), an aspect in which Ar² represents a p-phenylene group (constitutional unit derived from terephthalic acid), an aspect in which Ar² represents an m-phenylene group (constitutional unit derived from isophthalic acid), an aspect in which Ar² represents a 2,6-naphthylene group (constitutional unit derived from 2,6-naphthalenedicarboxylic acid), or an aspect in which Ar² represents a diphenylether-4,4′-diyl group (constitutional unit derived from diphenylether-4,4′-dicarboxylic acid) is preferable.

The constitutional unit (3) is a constitutional unit derived from an aromatic diol, an aromatic hydroxyamine, or an aromatic diamine.

As the constitutional unit (3), an aspect in which Ar³ represents a p-phenylene group (constitutional unit derived from hydroquinone, p-aminophenol, or p-phenylenediamine), an aspect in which Ar³ represents an m-phenylene group (constitutional unit derived from isophthalic acid), or an aspect in which Ar³ represents a 4,4′-biphenylylene group (constitutional unit derived from 4,4′-dihydroxybiphenyl, 4-amino-4′-hydroxybiphenyl, or 4,4′-diaminobiphenyl) is preferable.

A content of the constitutional unit (1) is preferably 30% by mole or more, more preferably 30% to 80% by mole, still more preferably 30% to 60% by mole, and particularly preferably 30% to 40% by mole with respect to the total amount of all constitutional units (a value obtained by dividing the mass of each constitutional unit (also referred to as “monomer unit”) constituting the liquid crystal polymer by the formula weight of each constitutional unit to calculate an amount (mole) equivalent to the substance amount of each constitutional unit and adding up the amounts).

A content of the constitutional unit (2) is preferably 35% by mole or less, more preferably 10% by mole to 35% by mole, still more preferably 20% by mole to 35% by mole, and particularly preferably 30% by mole to 35% by mole with respect to the total amount of all constitutional units.

A content of the constitutional unit (3) is preferably 35% by mole or less, more preferably 10% by mole to 35% by mole, still more preferably 20% by mole to 35% by mole, and particularly preferably 30% by mole to 35% by mole with respect to the total amount of all constitutional units.

The heat resistance, the strength, and the rigidity are likely to be improved as the content of the constitutional unit (1) increases, but the solubility in a solvent is likely to be decreased in a case where the content thereof is extremely large.

A proportion of the content of the constitutional unit (2) to the content of the constitutional unit (3) is expressed as [content of constitutional unit (2)]/[content of constitutional unit (3)] (mol/mol), and is preferably 0.9/1 to 1/0.9, more preferably 0.95/1 to 1/0.95, and still more preferably 0.98/1 to 1/0.98.

The liquid crystal polymer may have two or more kinds of each of the constitutional units (1) to (3) independently. In addition, the liquid crystal polymer may have a constitutional unit other than the constitutional units (1) to (3), but the content thereof is preferably 10% by mole or less and more preferably 5% by mole or less with respect to the total amount of all the constitutional units.

From the viewpoint of solubility in a solvent, the liquid crystal polymer preferably has, as the constitutional unit (3), a constitutional unit (3) in which at least one of X or Y is an imino group, that is, preferably has as the constitutional unit (3), at least one of a constitutional unit derived from an aromatic hydroxyamine or a constitutional unit derived from an aromatic diamine, and it is more preferable to have only a constitutional unit (3) in which at least one of X or Y is an imino group.

It is preferable that the liquid crystal polymer is produced by melt-polymerizing raw material monomers corresponding to the constitutional units constituting the liquid crystal polymer. The melt polymerization may be carried out in the presence of a catalyst. Examples of the catalyst include metal compounds such as magnesium acetate, stannous acetate, tetrabutyl titanate, lead acetate, sodium acetate, potassium acetate, and antimony trioxide, and nitrogen-containing heterocyclic compounds such as 4-(dimethylamino)pyridine and 1-methylimidazole; and preferred examples thereof include nitrogen-containing heterocyclic compounds. The melt polymerization may be further carried out by solid phase polymerization as necessary.

In addition, a weight-average molecular weight of the liquid crystal polymer is preferably 1,000,000 or less, more preferably 3,000 to 300,000, still more preferably 5,000 to 100,000, and particularly preferably 5,000 to 30,000. In a case where the weight-average molecular weight of the liquid crystal polymer is within the above-described range, the base material is excellent in thermal conductivity, heat resistance, strength, and rigidity in the thickness direction.

Examples of the fluorine-based polymer include polytetrafluoroethylene, polychlorotrifluoroethylene, polyvinylidene fluoride, polyvinyl fluoride, a perfluoroalkoxy fluororesin, an ethylene tetrafluoride/propylene hexafluoride copolymer, an ethylene/ethylene tetrafluoride copolymer, and an ethylene/chlorotrifluoroethylene copolymer.

Among these, polytetrafluoroethylene is preferable.

In addition, examples of the fluorine-based polymer include a fluorinated α-olefin monomer, that is, an α-olefin monomer containing at least one fluorine atom; and a homopolymer and a copolymer optionally containing a constitutional unit derived from a non-fluorinated ethylenically unsaturated monomer reactive to the fluorinated α-olefin monomer.

Examples of the fluorinated α-olefin monomer include CF₂═CF₂, CHF═CF₂, CH₂═CF₂, CHCl═CHF, CClF═CF₂, CCl₂═CF₂, CClF═CClF, CHF═CCl₂, CH₂═CClF, CCl₂═CClF, CF₃CF═CF₂, CF₃CF═CHF, CF₃CH═CF₂, CF₃CH═CH₂, CHF₂CH═CHF, CF₃CF═CF₂, and perfluoro (alkyl having 2 to 8 carbon atoms) vinyl ether (for example, perfluoromethyl vinyl ether, perfluoropropyl vinyl ether, and perfluorooctyl vinyl ether). Among these, at least one monomer selected from the group consisting of tetrafluoroethylene (CF₂═CF₂), chlorotrifluoroethylene (CClF═CF₂), (perfluorobutyl)ethylene, vinylidene fluoride (CH₂═CF₂), and hexafluoropropylene (CF₂═CFCF₃) is preferable.

Examples of the non-fluorinated ethylenically unsaturated monomer include ethylene, propylene, butene, and an ethylenically unsaturated aromatic monomer (for example, styrene and α-methylstyrene).

The fluorinated α-olefin monomer may be used alone or in combination of two or more thereof.

In addition, the non-fluorinated ethylenically unsaturated monomer may be used alone or in combination of two or more thereof.

Examples of the fluorine-based polymer include poly(chlorotrifluoroethylene) (PCTFE), poly(chlorotrifluoroethylene-propylene), poly(ethylene-tetrafluoroethylene) (ETFE), poly(ethylene-chlorotrifluoroethylene) (ECTFE), poly(hexafluoropropylene), poly(tetrafluoroethylene) (PTFE), poly(tetrafluoroethylene-ethylene-propylene), poly(tetrafluoroethylene-hexafluoropropylene) (also referred to as a fluorinated ethylene-propylene copolymer (FEP)), poly(tetrafluoroethylene-propylene) (also referred to as a fluoroelastomer (FEPM)), poly(tetrafluoroethylene-perfluoropropylene vinyl ether), a copolymer having a tetrafluoroethylene main chain and a fully fluorinated alkoxy side chain (perfluoroalkoxy polymer; also referred to as a poly(tetrafluoroethylene-perfluoroalkyl vinyl ether) (PFA)) (for example, poly(tetrafluoroethylene-erfluoropropylene propyl vinyl ether)), polyvinyl fluoride (PVF), polyvinylidene fluoride (PVDF), poly(vinylidene fluoride-chlorotrifluoroethylene), perfluoropolyether, perfluorosulfonic acid, and perfluoropolyoxetane.

The fluorine-based polymer may be used alone or in combination of two or more thereof.

The fluorine-based polymer is preferably at least one of FEP, PFA, ETFE, or PTFE. These may have fibril-forming properties or non-fibril-forming properties. The FEP is available from Du Pont as the trade name of TEFLON (registered trademark) FEP or from DAIKIN INDUSTRIES, LTD. as the trade name of NEOFLON FEP; and the PFA is available from DAIKIN INDUSTRIES, LTD. as the trade name of NEOFLON PFA, from Du Pont as the trade name of TEFLON (registered trademark) PFA, or from Solvay Solexis as the trade name of HYFLON PFA.

The fluorine-based polymer preferably includes PTFE. The PTFE can be included as a PTFE homopolymer, a partially modified PTFE homopolymer, or a combination including one or both of these. The partially modified PTFE homopolymer preferably contains a constitutional unit derived from a comonomer other than tetrafluoroethylene in an amount of less than 1% by mass based on the total mass of the polymer.

The fluorine-based polymer may be a crosslinkable fluoropolymer having a crosslinkable group. The crosslinkable fluoropolymer can be crosslinked by a known crosslinking method in the related art. One of the representative crosslinkable fluoropolymers is a fluoropolymer having a (meth)acryloxy group. For example, the crosslinkable fluoropolymer can be represented by Formula:

H₂C═CR′COO—(CH₂)ₙ—R—(CH₂)ₙ—OOCR′═CH₂
in the formula, R is a fluorine-based oligomer chain having two or more constitutional units derived from the fluorinated α-olefin monomer or the non-fluorinated monoethylenically unsaturated monomer, R′ is H or —CH₃, and n is 1 to 4. R may be a fluorine-based oligomer chain having a constitutional unit derived from tetrafluoroethylene.

In order to initiate a radical crosslinking reaction through the (meth)acryloxy group in the fluorine-based polymer, by exposing the fluoropolymer having a (meth)acryloxy group to a free radical source, a crosslinked fluoropolymer network can be formed. The free radical source is not particularly limited, and suitable examples thereof include a photoradical polymerization initiator and an organic peroxide. Appropriate photoradical polymerization initiators and organic peroxides are well known in the art. The crosslinkable fluoropolymer is commercially available, and examples thereof include Viton B manufactured by Du Pont.

Examples of the polymerized substance of a compound which has a cyclic aliphatic hydrocarbon group and a group having an ethylenically unsaturated bond include thermoplastic resins having a constitutional unit formed from a monomer having a cyclic olefin such as norbornene and a polycyclic norbornene-based monomer, which is also referred to as a thermoplastic cyclic olefin-based resin.

The polymerized substance of a compound which has a cyclic aliphatic hydrocarbon group and a group having an ethylenically unsaturated bond may be a ring-opened polymer of the above-described cyclic olefin, a hydrogenated product of a ring-opened copolymer using two or more cyclic olefins, or an addition polymer of a cyclic olefin and a linear olefin or aromatic compound having an ethylenically unsaturated bond such as a vinyl group. In addition, a polar group may be introduced into the polymerized substance of a compound which has a cyclic aliphatic hydrocarbon group and a group having an ethylenically unsaturated bond.

The polymerized substance of a compound which has a cyclic aliphatic hydrocarbon group and a group having an ethylenically unsaturated bond may be used alone or in combination of two or more thereof.

A ring structure of the cyclic aliphatic hydrocarbon group may be a single ring, a fused ring in which two or more rings are fused, or a crosslinked ring.

Examples of the ring structure of the cyclic aliphatic hydrocarbon group include a cyclopentane ring, a cyclohexane ring, a cyclooctane ring, an isophorone ring, a norbornane ring, and a dicyclopentane ring.

The compound which has a cyclic aliphatic hydrocarbon group and a group having an ethylenically unsaturated bond may be a monofunctional ethylenically unsaturated compound or a polyfunctional ethylenically unsaturated compound.

The number of cyclic aliphatic hydrocarbon groups in the compound which has a cyclic aliphatic hydrocarbon group and a group having an ethylenically unsaturated bond may be 1 or more, and may be 2 or more.

It is sufficient that the polymerized substance of a compound which has a cyclic aliphatic hydrocarbon group and a group having an ethylenically unsaturated bond is a polymer obtained by polymerizing at least one compound which has a cyclic aliphatic hydrocarbon group and a group having an ethylenically unsaturated bond, and it may be a polymerized substance of two or more kinds of the compound which has a cyclic aliphatic hydrocarbon group and a group having an ethylenically unsaturated bond or a copolymer with other ethylenically unsaturated compounds having no cyclic aliphatic hydrocarbon group.

In addition, the polymerized substance of a compound which has a cyclic aliphatic hydrocarbon group and a group having an ethylenically unsaturated bond is preferably a cycloolefin polymer.

In the polyphenylene ether, from the viewpoint of dielectric loss tangent and heat resistance, the average number of molecular terminal phenolic hydroxyl groups per molecule (the number of terminal hydroxyl groups) is preferably 1 to 5 and more preferably 1.5 to 3.

The number of hydroxyl groups or the number of phenolic hydroxyl groups in the polyphenylene ether can be found, for example, from a standard value of a product of the polyphenylene ether. In addition, examples of the number of terminal hydroxyl groups or the number of terminal phenolic hydroxyl groups include a numerical value representing an average value of hydroxyl groups or phenolic hydroxyl groups per molecule of all polyphenylene ethers present in 1 mol of the polyphenylene ether.

The polyphenylene ether may be used alone or in combination of two or more thereof.

Examples of the polyphenylene ether include a polyphenylene ether including 2,6-dimethylphenol and at least one of bifunctional phenol or trifunctional phenol, and a compound mainly including the polyphenylene ether, such as poly(2,6-dimethyl-1,4-phenylene oxide). More specifically, for example, a compound having a structure represented by Formula (PPE) is preferable.

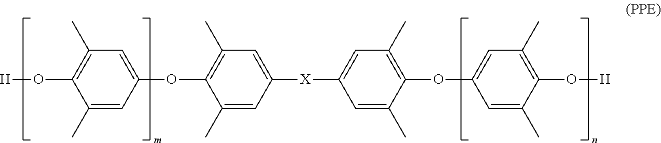

In Formula (PPE), X represents an alkylene group having 1 to 3 carbon atoms or a single bond, m represents an integer of 0 to 20, n represents an integer of 0 to 20, and the sum of m and n represents an integer of 1 to 30.

Examples of the alkylene group in X described above include a dimethylmethylene group.

The aromatic polyether ketone is not particularly limited, and a known aromatic polyether ketone can be used.

The aromatic polyether ketone is preferably a polyether ether ketone.

The polyether ether ketone is one type of the aromatic polyether ketone, and is a polymer in which bonds are arranged in the order of an ether bond, an ether bond, and a carbonyl bond (ketone). It is preferable that the bonds are linked to each other by a divalent aromatic group.

The aromatic polyether ketone may be used alone or in combination of two or more thereof.

Examples of the aromatic polyether ketone include polyether ether ketone (PEEK) having a chemical structure represented by Formula (P1), polyether ketone (PEK) having a chemical structure represented by Formula (P2), polyether ketone ketone (PEKK) having a chemical structure represented by Formula (P3), polyether ether ketone ketone (PEEKK) having a chemical structure represented by Formula (P4), and polyether ketone ether ketone ketone (PEKEKK) having a chemical structure represented by Formula (P5).

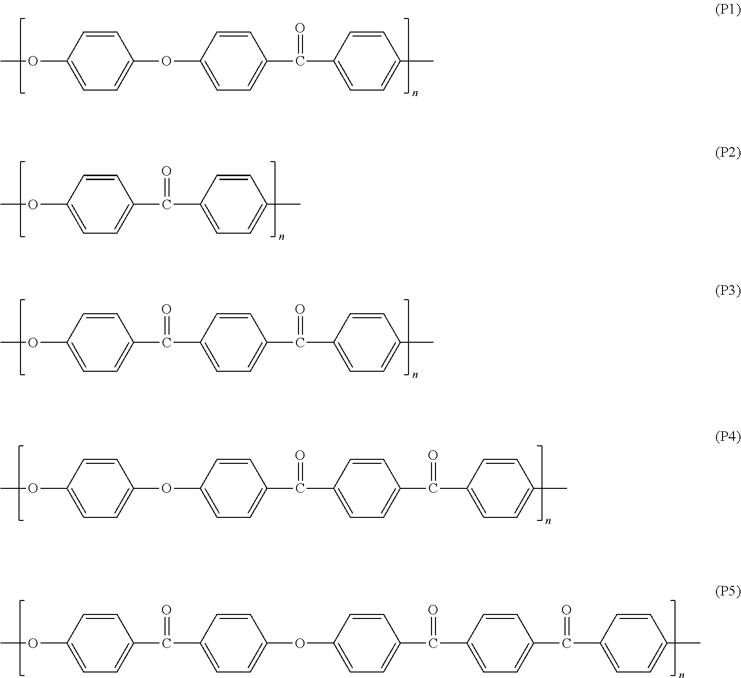

From the viewpoint of mechanical properties, each n of Formulae (P1) to (P5) is preferably 10 or more and more preferably 20 or more. On the other hand, from the viewpoint that the aromatic polyether ketone can be easily produced, n is preferably 5,000 or less and more preferably 1,000 or less. That is, n is preferably 10 to 5,000 and more preferably 20 to 1,000.

A content of the resin with respect to the total mass of the elastic layers is not particularly limited, but is preferably 3% by mass to 60% by mass, more preferably 5% by mass to 50% by mass, still more preferably 10% by mass to 40% by mass, and particularly preferably 15% by mass to 30% by mass.

The elastic layer may contain at least one filler. The filler may be an organic filler or an inorganic filler.

Examples of the organic filler include particles of a liquid crystal polymer, polyolefin, a fluorine-based polymer, and the like.

Examples of the inorganic filler include particles of silica, alumina, titania, zirconia, kaolin, calcined kaolin, talc, mica, sodium carbonate, calcium carbonate, aluminum hydroxide, magnesium hydroxide, zinc oxide, and the like.

From the viewpoint of reducing the thermal expansion coefficient, it is preferable that the elastic layer contains silica particles.

From the viewpoint of thermal expansion coefficient and adhesiveness with the pattern, an average particle diameter of the filler is preferably 5 nm to 20 μm, more preferably 10 nm to 10 μm, still more preferably 20 nm to 1 μm, and particularly preferably 25 nm to 500 nm.

In the present disclosure, the average particle diameter of the filler is obtained by arithmetically averaging particle diameters of 50 particles randomly selected from an image of a scanning electron microscope (SEM).

From the viewpoint of thermal expansion coefficient of the base material and adhesiveness with the pattern, a content of the filler with respect to the total mass of the base material is preferably 10% by mass to 40% by mass, more preferably 15% by mass to 35% by mass, and still more preferably 20% by mass to 30% by mass.

### (Additive)

The elastic layer may contain various additives, and examples thereof include a polymerization initiator, a dispersant, a surfactant, a crosslinking agent, and an antioxidant.

From the viewpoint of adhesiveness between the base material and the pattern and viewpoint of suppressing the occurrence of cracks in the pattern, a thickness of the elastic layer is preferably 1 μm to 20 μm, more preferably 2 μm to 19 μm, still more preferably 3 μm to 18 μm, particularly preferably 5 μm to 17 μm, and most preferably 7 μm to 15 μm.

Layer Other than Elastic Layer

The base material may include a layer other than the elastic layer.

The layer other than the elastic layer can contain the above-described resin.

From the viewpoint of dielectric loss tangent, adhesiveness with the pattern, and heat resistance, the resin is preferably at least one selected from the group consisting of a liquid crystal polymer, a fluorine-based polymer, a polymerized substance of a compound which has a cyclic aliphatic hydrocarbon group and a group having an ethylenically unsaturated bond, polyphenylene ether, aromatic polyether ketone, and an epoxy resin, and more preferably at least one selected from the group consisting of a liquid crystal polymer and a fluorine-based polymer.

From the viewpoint of adhesiveness with the pattern and mechanical strength, a liquid crystal polymer is preferable, and from the viewpoint of heat resistance and dielectric loss tangent, a fluorine-based polymer is preferable.

A content of the resin with respect to the total mass of the layer other than the elastic layer is not particularly limited, but is preferably 30% by mass to 100% by mass, more preferably 35% by mass to 100% by mass, still more preferably 40% by mass to 100% by mass, and particularly preferably 45% by mass to 100% by mass.

The layer other than the elastic layer can contain the above-described filler.

From the viewpoint of thermal expansion coefficient of the base material and adhesiveness with the pattern, a content of the filler with respect to the total mass of the layer other than the elastic layer is preferably 10% by mass to 70% by mass, more preferably 15% by mass to 65% by mass, still more preferably 20% by mass to 60% by mass, and particularly preferably 35% by mass to 55% by mass.

From the viewpoint of electrical characteristics, a dielectric loss tangent of the base material is preferably 0.01 or less, more preferably 0.0005 to 0.007, still more preferably 0.001 to 0.006, and particularly preferably 0.001 to 0.005.

The dielectric loss tangent of the base material can be adjusted by changing a material to be contained in the base material, or the like.

In the present disclosure, the dielectric loss tangent of the base material is measured by the following terahertz time-domain spectroscopy (THz-TDS).

First, the base material is cut into a test piece having a size of 100 mm×100 mm.

Next, an optical system for transmission-type terahertz spectroscopy is produced, and a dielectric loss tangent of the test piece is measured from a change in time waveform of the electric field (frequency: 1 THz) before and after insertion of the test piece in an environment of a temperature of 25° C. and a humidity of 10% RH.

In a case where the pattern described later is formed on the surface of the base material, the above-described measurement of the dielectric loss tangent is carried out using a base material etched with a solution such as iron chloride.

From the viewpoint of crack suppressibility, the thermal expansion coefficient of the base material is more preferably-20 ppm/K to 65 ppm/K, still more preferably 0 ppm/K to 55 ppm/K, and particularly preferably 5 ppm/K to 45 ppm/K.

The thermal expansion coefficient of the base material can be adjusted by changing a material to be contained in the base material, or the like.

In the present disclosure, the thermal expansion coefficient is measured by the following method.

First, the base material is cut into a test piece having a size of 5 mm×20 mm.

Next, using a thermomechanical analyzer (TMA), a tensile load of 1 g is applied to both ends of the test piece in a longitudinal direction, the temperature is raised from 25° C. to 150° C. at a rate of 5° C./min, and the thermal expansion coefficient is calculated from a slope of a TMA curve between 125° C. and 50° C. in a case where the temperature is lowered to 25° C.

From the viewpoint of cost reduction, in the metamaterial according to the present disclosure, a ratio of a product of a thickness of the pattern and a storage elastic modulus of the pattern at 25° C. to a product of a thickness of the base material and a storage elastic modulus of the base material at 25° C. (Product of thickness of pattern and storage elastic modulus of pattern at 25° C./Product of thickness of base material and storage elastic modulus of base material at 25° C.) is preferably less than 10, more preferably 0.01 to 1.0, and still more preferably 0.03 to 0.5.

A thickness of the base material is not particularly limited, and from the viewpoint of handleability, it is preferably 30 μm to 200 μm, more preferably 40 μm to 180 μm, and still more preferably 40 μm to 150 μm.

As the base material, a base material which is produced by a known method in the related art may be used, or a commercially available base material may be used.

In addition, as the base material, a woven fabric such as a glass cloth, a nonwoven fabric, or the like may be used by being impregnated with the above-described resin. Furthermore, a layer may be formed on at least one surface of the glass cloth or the like, impregnated with the above-described resin, using the above-described material such as the resin to be a base material having a multilayer structure.

A method for producing the base material will be described with reference to Examples.

### (Pattern)

The pattern is composed of at least one of a conductive material or a material which transits from an insulator to a conductor.

The conductive material preferably contains a metal, and more preferably is one or more selected from the group consisting of gold, silver, platinum, copper, and aluminum. Among these, from the viewpoint of smoothness of the pattern, adhesiveness with the base material, and the like, at least one of gold or copper is particularly preferable.

A content of the metal with respect to the total mass of the conductive material is not particularly limited, and may be 80% by mass or more, 90% by mass or more, or 100% by mass.

As the material which transits from an insulator to a conductor, a material which transits from an insulator to a conductor by heating, light irradiation, or applying a voltage can be used.

The material which transits from an insulator to a conductor is preferably one or more selected from the group consisting of a phase change material, a semiconductor, a conductive oxide, and a carbon material.

In the present disclosure, the phase change material means a material which causes a phase change between an amorphous phase and a crystalline phase by Joule heat due to an electric pulse.

Examples of the phase change material include vanadium oxide, an antimony tellurium (SbTe) alloy, a germanium tellurium (GeTe) alloy, a germanium antimony tellurium (GeSbTe) alloy, an indium antimony tellurium (InSbTe) alloy, and a silver indium antimony tellurium (AgInSbTe) alloy. Among these, from the viewpoint of easily controlling a temperature and a voltage at which the insulator is transited to the conductor, smoothness of the pattern, adhesiveness with the base material, and the like, vanadium oxide or a GeSbTe alloy is preferable.

Examples of the semiconductor include a p-type x-conjugated polymer, a condensed polycyclic compound, a triarylamine compound, a hetero 5-membered ring compound, a phthalocyanine compound, and a porphyrin compound.

Examples of the conductive oxide include indium tin oxide (ITO), indium zinc oxide (IZO), zinc oxide (ZnO), and indium gallium zinc oxide (IGZO).

Examples of the carbon material include carbon nanotube and graphene.

The pattern may include a plurality of structural bodies. The pattern may include two or more structural bodies having different shapes, sizes, and the like.

A shape of the structural body is not particularly limited, but is preferably a shape capable of inducing a dielectric or magnetic response change by generating a charge bias, a current, or the like in the structural body or between adjacent structural bodies due to an interaction between the electric field, the magnetic field, or the like of an electromagnetic wave in a terahertz band, which is incident on the metamaterial.

The shape of the structural body is not particularly limited, and examples thereof include a C-shape, a U-shape, a double ring shape, a V-shape, an L-shape, a lattice shape, a spiral shape, a square shape, a circular shape, and a cross shape in an in-plane direction of the base material. The structural body is composed of the conductive material or the material which transits from an insulator to a conductor.

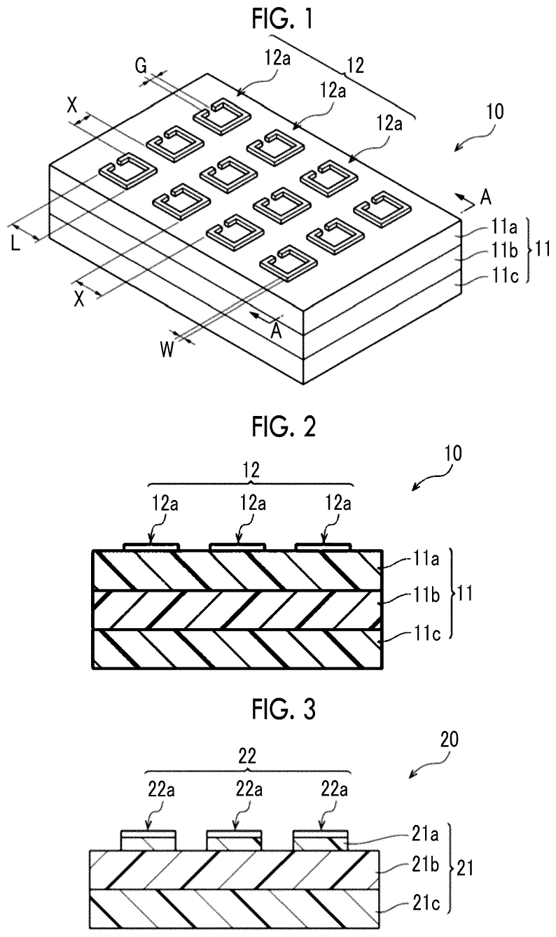

The structural body is preferably a split-ring resonator. The split-ring resonator means a structural body having a C-shape or a U-shape, and has a gap indicated by a reference numeral G in FIG. 1.

A size of the structural body is not particularly limited, but is preferably equal to or less than a wavelength size of the incident electromagnetic wave in the terahertz band.

In the present disclosure, the maximum length of the structural body means a length which is longest in a case where a straight line is drawn from one end to the other end of the structural body in the in-plane direction of the base material.

From the viewpoint of smoothness of the pattern, a width of the structural body is preferably 3 μm to 25 μm.

In addition, in a case where the structural body is a split-ring resonator, from the viewpoint of smoothness of the pattern, the gap is preferably 1 μm to 15 μm.

A distance between the structural bodies is preferably appropriately changed according to the shape, size, and the like of the structural body, and for example, it can be set to 30 μm to 400 μm.

A disposition position of the structural body on the surface of the base material is not particularly limited, and is preferably a disposition in which the structural body resonates with the electromagnetic wave in the terahertz band.

In addition, the structural body may be disposed on the surface of the base material, in which a periodic structure is formed such that the amount of phase shift of the electromagnetic wave in the terahertz band is continuously increased or decreased as the region goes from the center of the surface of the base material to the outer side. Examples of the above-described periodic structure include a structure in which structural bodies having different diameters are arranged in a concentric circle. A change width of the diameter of the structural bodies arranged in a concentric circle can be set to 10 μm to 200 μm.

From the viewpoint of cost reduction, a thickness of the pattern is preferably less than 5 μm, more preferably 0.05 μm to 4 μm, still more preferably 0.1 μm to 3 μm, and particularly preferably 0.3 μm to 1 μm.

A method of forming the pattern is not particularly limited, and for example, the pattern can be formed by forming a sputtered film on the surface of the base material by a sputtering method, forming a resist pattern on a surface of the sputtered film, etching and removing the sputtered film not covered with the resist pattern, and then removing the resist pattern.

The method of forming the pattern is not limited to the above-described methods, and the thin film may be formed by a vapor deposition method instead of the sputtering method.

An embodiment of the metamaterial will be described with reference to FIGS. 1 to 3. However, the metamaterial is not limited thereto.

As shown in FIG. 1, a metamaterial 10 includes a base material 11 and a pattern 12 provided on a surface of the base material 11.

In FIG. 1, the base material 11 includes an elastic layer 11a, and layers 11b and 11c other than the elastic layer.

In FIG. 1, the pattern 12 includes a plurality of structural bodies 12a. In FIG. 1, the maximum length of the structural body 12a is indicated by a reference numeral L, the width of the structural body 12a is indicated by a reference numeral W, the gap of the structural body 12a is indicated by a reference numeral G, and the distance between the structural bodies is indicated by a reference numeral X.

FIG. 2 is a cross-sectional view taken along a line A-A of the metamaterial in FIG. 1. As shown in FIG. 2, the elastic layer 11a may be provided on the entire surface of the layer 11b other than the elastic layer, or may be provided on a part of the surface.

FIG. 3 is a cross-sectional view of a metamaterial in which an elastic layer 21a is provided on a part of a surface of a layer 21b other than the elastic layer. From the viewpoint of adhesiveness between the base material and the pattern and viewpoint of suppressing the occurrence of cracks in the pattern, it is preferable that the elastic layer 21a is provided in at least a region where a structural body 22a is provided.

The applications of the metamaterial according to the present disclosure are not particularly limited, and examples thereof include a flat lens, a diffraction grating, a wavelength filter, a polarizer, a sensor, a reflector, and a flat prism.

In addition, the use environment thereof is not particularly limited, and the metamaterial may be mounted on an electronic apparatus or the like or may be installed outdoors as a wavelength filter.

### [Laminate]

The laminate according to the present disclosure includes the above-described metamaterial and an organic film provided on a surface of the metamaterial on the pattern side. The organic film may have a monolayer structure or a multilayer structure.

From the viewpoint of suppressing occurrence of corrosion in the pattern, a moisture permeability of the organic film in an environment of a temperature of 40° C. and a relative humidity of 90% is preferably 3,000 g/(m²·24 hours) or less, more preferably 2,000 g/(m²·24 hours) or less, still more preferably 1,500 g/(m²·24 hours) or less, and particularly preferably 1,000 g/(m²·24 hours) or less.

The organic film can contain a resin. The resin is as described above, and the description thereof will be omitted here.

A content of the resin with respect to the total mass of the organic film is not particularly limited, but is preferably 10% by mass to 90% by mass, more preferably 20% by mass to 80% by mass, and still more preferably 30% by mass to 70% by mass.

The organic film may contain an ultraviolet absorber. As a result, it is possible to improve weather fastness of the laminate and to improve suitability of the laminate for applications of being installed outdoors.

Examples of the ultraviolet absorber include a conjugated diene compound, an aminodiene compound, a salicylate compound, a benzophenone compound, a benzotriazole compound, an acrylonitrile compound, a hydroxyphenyltriazine compound, an indole compound, and a triazine compound.

In addition, in a case where the organic film has a multilayer structure, the organic film preferably includes a layer containing the ultraviolet absorber.

From the viewpoint of weather fastness and prevention of bleed out, a content of the ultraviolet absorber with respect to the total mass of the organic film is preferably 0.01% by mass to 30% by mass, more preferably 0.1% by mass to 10% by mass, and still more preferably 0.5% by mass to 5% by mass.

The organic film may contain the above-described additives.

A thickness of the organic film is not particularly limited, but from the viewpoint that transmission characteristics of the electromagnetic wave are not impaired, it is preferably 20 μm or less, more preferably 10 μm or less, and still more preferably 5 μm or less. The lower limit thereof is not particularly limited, but is 0.5 μm or more in many cases.

A method for manufacturing the laminate is not particularly limited, and the laminate may be formed by adding the above-described resin and the like to a solvent as necessary to form a composition, and applying the composition onto the surface of the metamaterial and drying the composition. In addition, the laminate may be manufactured by applying the composition onto a temporary support and drying the composition to form an organic film, producing a transfer sheet, and transferring the organic film from the transfer sheet to a surface of the metamaterial.

### EXAMPLES

Hereinafter, the above-described embodiment will be specifically described with reference to Examples, but the above-described embodiment is not limited to Examples. Unless otherwise specified, the unit of numerical values in Table 1 is part by mass. In addition, the content in Table 1 indicates a content as the solid content.

### Synthesis Example 1: Synthesis of Liquid Crystal Polyester LC-A

A reactor including a stirrer, a torque meter, a nitrogen gas introduction pipe, a thermometer, and a reflux condenser was prepared.

940.9 g (5.0 mol) of 6-hydroxy-2-naphthoic acid, 377.9 g (2.5 mol) of 4-hydroxyacetaminophen, 415.3 g (2.5 mol) of isophthalic acid, and 867.8 g (8.4 mol) of acetic acid anhydride were charged into the above-described reactor, the gas in the reactor was replaced with nitrogen gas, and the mixture was heated from room temperature (23° C.) to 143° C. over 60 minutes while being stirred under a nitrogen gas stream and was refluxed at 143° C. for 1 hour.

Thereafter, the mixture was heated from 150° C. to 300° C. over 5 hours while distilling off by-product acetic acid and unreacted acetic acid anhydride and maintained at 300° C. for 30 minutes, and the resultant was taken out from the reactor and cooled to room temperature. The obtained solid matter was crushed with a crusher, thereby obtaining powdery liquid crystal polyester A1.

The liquid crystal polyester A1 obtained above was heated from room temperature to 160° C. over 2 hours and 20 minutes in a nitrogen atmosphere, further heated from 160° C. to 180° C. over 3 hours and 20 minutes, maintained at 180° C. for 5 hours to carry out solid phase polymerization, cooled, and crushed with a crusher, thereby obtaining powdery liquid crystal polyester A2.

The liquid crystal polyester A2 was heated from room temperature (23° C.) to 180° C. over 1 hour and 20 minutes in a nitrogen atmosphere, further heated from 180° C. to 240° C. over 5 hours, maintained at 240° C. for 5 hours to carry out solid phase polymerization, and cooled, thereby obtaining powdery liquid crystal polyester LC-A.

### Preparation Example 1: Preparation of Filler F-1

1034.99 g (5.5 mol) of 2-hydroxy-6-naphthoic acid, 378.33 g (1.75 mol) of 2,6-naphthalenedicarboxylic acid, 83.07 g (0.5 mol) of terephthalic acid, 272.52 g (2.475 mol) of hydroquinone (0.225 mol excess with respect to the total molar amount of the 2,6-naphthalenedicarboxylic acid and the terephthalic acid), 1226.87 g (12 mol) of acetic acid anhydride, and 0.17 g of 1-methylimidazole as a catalyst were charged into the above-described reactor. After the gas in the reactor was replaced with nitrogen gas, the mixture was heated from room temperature to 145° C. over 15 minutes while being stirred in a nitrogen gas stream and was refluxed at 145° C. for 1 hour.

Next, the mixture was heated from 145° C. to 310° C. over 3 hours 30 minutes while distilling off by-product acetic acid and unreacted acetic acid anhydride and maintained at 310° C. for 3 hours, and solid liquid crystal polyester LC-B was taken out and cooled to room temperature. The flow start temperature of the liquid crystal polyester LC-B was 265° C.

Using a jet mill (manufactured by KURIMOTO Ltd., KJ-200), the liquid crystal polyester LC-B was crushed to obtain a filler F-1. An average particle diameter of the filler F-1 was 9 μm.

### Example 1

The liquid crystal polyester shown in Table 1 was added to N-methylpyrrolidone, and the mixture was stirred at 140° C. for 4 hours in a nitrogen atmosphere to form a solution, and allowed to pass through a sintered fiber metal filter having a nominal pore diameter of 10 μm and then allowed to pass through a sintered fiber metal filter having the same nominal pore diameter of 10 μm to obtain a composition A.

A thermoplastic elastomer A-1 (manufactured by Mitsui Chemicals, Inc., TAFMER (registered trademark) MH7020, maleic acid anhydride-modified polyolefin, Tg: −65° C.) shown in Table 1 was frozen and crushed to obtain a powder, and the powder was added to the composition A and stirred at 25° C. for 30 minutes to obtain a composition B.

In addition, the filler F-1 shown in Table 1 was added to the composition A, and the mixture was stirred at 25° C. for 30 minutes to obtain a composition C.

The contents of the liquid crystal polyester, the thermoplastic elastomer, and the filler in the compositions A to C are shown in Table 1. The concentration of solid contents of the liquid crystal polyester in the compositions A to C was set to 10% by mass.

The composition A to composition C were fed to a casting die equipped with a multi-manifold for co-casting, and cast on an aluminum foil having a thickness of 50 μm as a support to produce a base material having a three-layer structure of a layer formed of the composition B and having a thickness of 10 μm (referred to as a first layer in Table 1), a layer formed the composition C and having a thickness of 35 μm (referred to as a second layer in Table 1), and a layer formed of the composition A and having a thickness of 5 μm (referred to as a third layer in Table 1). The aluminum foil was in contact with the third layer.

The above-described base material was dried at 40° C. for 4 hours to remove the solvent from the base material, and the base material was further heated from room temperature (25° C.) to 290° C. at 1° C./min under a nitrogen atmosphere to perform a heat treatment of maintaining the temperature for 2 hours, and the base material was cooled to room temperature, and then the aluminum foil was peeled off and further heated at 200° C. for 1 minute.

In a case where a dielectric loss tangent of the base material produced as described above was measured by the following terahertz time-domain spectroscopy (THz-TDS), it was 0.003.

First, the base material was cut into a test piece having a size of 100 mm×100 mm.

Next, an optical system for transmission-type terahertz spectroscopy was produced, and a dielectric loss tangent of the test piece was measured from a change in time waveform of the electric field (frequency: 1 THz) before and after insertion of the test piece in an environment of a temperature of 25° C. and a humidity of 10% RH.

In a case where a thermal expansion coefficient of the base material produced as described above was measured by the following method, it was 42 ppm/K.

First, the base material was cut into a test piece having a size of 5 mm×20 mm.

Next, using a thermomechanical analyzer (TMA), a tensile load of 1 g was applied to both ends of the test piece in a longitudinal direction, the temperature was raised from 25° C. to 150° C. at a rate of 5° C./min, and the thermal expansion coefficient was calculated from a slope of a TMA curve between 125° C. and 50° C. in a case where the temperature was lowered to 25° C.

In a case where an elastic recovery rate of the first layer (elastic layer) provided in the base material produced as described above was measured by the following nano-indentation method, it was less than 80%.

A cross-sectional sample of the base material was cut out using a microtome.

Using a nano-indenter (product name “Triboindenter”, manufactured by Hysitron, Inc.), a load was applied to the elastic layer of the cross-sectional sample by pushing the indenter from a side surface direction, and then the indenter was returned to unload, thereby obtaining a load-displacement curve.

The elastic recovery rate was obtained from a ratio (V2/V1×100) of a maximum displacement amount V1 of the obtained curve and a difference V2 in displacement amount at which the load was 0 in a case where the indenter was returned from the maximum displacement amount.

In the actual measurement, the measurement mode was set to a single indentation measurement, the measurement temperature was set to 25° C., a Berkovich (pyramidal) type diamond indenter was used as the indenter, the indentation depth of the indenter with respect to the cross-sectional sample was set to 300 nm, the indentation speed of the indenter was set to 10 nm/sec, and the pulling-out speed of the indenter from the cross-sectional sample was set to 10 nm/sec.

The base material was cut into a test piece having a size of 10 mm×150 mm.

In a case where a storage elastic modulus of the above-described test piece was measured under conditions of a distance between chucks of 100 mm, a temperature of 25° C., and a relative humidity of 50%, in conformity with the method described in JIS K 7127 (1999), it was 3.4 GPa.

A sputtered copper film having a thickness of 0.5 μm was formed on the surface of the first layer of the above-described base material.

A resist pattern was formed on the surface of the sputtered film, the sputtered film not covered with the resist pattern was etched and removed, and then the resist pattern was removed to form a pattern including a plurality of C-shaped split-ring resonators, thereby obtaining a metamaterial.

The split-ring resonator had a width of 15 μm, a maximum length of 92 μm, a C-shape in a shape viewed from a normal direction of the base material, a gap of 10 μm, and a distance between the split-ring resonators of 200 μm.

The above-described pattern was cut out into a size of 5 mm×5 mm to produce a test piece.

In a case where a storage elastic modulus of the above-described test piece was measured using a scanning probe microscope (SPA400, manufactured by SII NanoTechnology Inc.) in a VE-AFM mode under conditions of a temperature of 25° C. and a relative humidity of 50%, it was 30 GPa.

A composition containing 98.0 parts by mass of a cycloolefin polymer P-1 (manufactured by JSR Corporation, ARTON (registered trademark) F3500), 2 parts by mass of an ultraviolet absorber having the following structure, and 400 parts by mass of dichloromethane was applied onto the surface of the metamaterial produced as described above on the pattern side, dried, and formed into an organic film having a thickness of 10 μm, thereby obtaining a laminate.

In a case where a moisture permeability was measured under conditions of a temperature of 40° C., a relative humidity of 90%, and 24 hours of standing, in conformity with the method of JIS Z 0208 (1976), it was 360 g/(m²·24 hours).

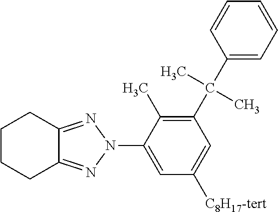

### Example 2

A metamaterial and a laminate were produced in the same manner as in Example 1, except that the contents of the liquid crystal polyester and the thermoplastic elastomer A-1 in the first layer were changed to the numerical values shown in Table 1.

In a case where a dielectric loss tangent of the base materials was measured by the same method as in Example 1, it was 0.002.

In a case where a thermal expansion coefficient of the base material was measured by the same method as in Example 1, it was 42 ppm/K.

In a case where an elastic recovery rate of the elastic layer provided in the base material was measured by the same method as in Example 1, it was less than 80%.

In addition, in a case where a storage elastic modulus of the base material and the pattern at 25° C. was measured by the same method as in Example 1, and it was 3.1 GPa and 30 GPa.

### Example 3

A metamaterial and a laminate were produced in the same manner as in Example 2, except that the filler F-1 was changed to a filler F-2 (copolymer particles of ethylene tetrafluoride and perfluoroalkoxy ethylene (PFA); melting point: 280° C., average particle diameter: 0.2 μm to 0.5 μm, dielectric loss tangent: 0.001).

In a case where a dielectric loss tangent of the base materials was measured by the same method as in Example 1, it was 0.002.

In a case where a thermal expansion coefficient of the base material was measured by the same method as in Example 1, it was 43 ppm/K.

In a case where an elastic recovery rate of the elastic layer provided in the base material was measured by the same method as in Example 1, it was less than 80%.

In addition, in a case where a storage elastic modulus of the base material and the pattern at 25° C. was measured by the same method as in Example 1, and it was 2.8 GPa and 30 GPa.

### Example 4

A metamaterial and a laminate were produced in the same manner as in Example 2, except that the thicknesses of the first layer and the second layer were changed to the numerical values shown in Table 1.

In a case where a dielectric loss tangent of the base materials was measured by the same method as in Example 1, it was 0.002.

In a case where a thermal expansion coefficient of the base material was measured by the same method as in Example 1, it was 42 ppm/K.

In a case where an elastic recovery rate of the elastic layer provided in the base material was measured by the same method as in Example 1, it was less than 80%.

In addition, in a case where a storage elastic modulus of the base material and the pattern at 25° C. was measured by the same method as in Example 1, and it was 3.3 GPa and 30 GPa.

### Example 5

A metamaterial and a laminate were produced in the same manner as in Example 4, except that the filler F-1 was changed to a filler F-3 (silica particles having an average particle diameter of 0.5 μm, manufactured by Admatechs Co., Ltd., SO-C2).

In a case where a dielectric loss tangent of the base materials was measured by the same method as in Example 1, it was 0.002.

In a case where a thermal expansion coefficient of the base material was measured by the same method as in Example 1, it was 30 ppm/K.

In a case where an elastic recovery rate of the elastic layer provided in the base material was measured by the same method as in Example 1, it was less than 80%.

In addition, in a case where a storage elastic modulus of the base material and the pattern at 25° C. was measured by the same method as in Example 1, and it was 6.6 GPa and 30 GPa.

### Example 6

A metamaterial and a laminate were produced in the same manner as in Example 2, except that the thermoplastic elastomer A-1 was changed to a thermoplastic elastomer A-2 (manufactured by ZEON CORPORATION, Quintac (registered trademark) 3520).

In a case where a dielectric loss tangent of the base materials was measured by the same method as in Example 1, it was 0.002.

In a case where a thermal expansion coefficient of the base material was measured by the same method as in Example 1, it was 42 ppm/K.

In a case where an elastic recovery rate of the elastic layer provided in the base material was measured by the same method as in Example 1, it was less than 80%.

In addition, in a case where a storage elastic modulus of the base material and the pattern at 25° C. was measured by the same method as in Example 1, and it was 3.4 GPa and 30 GPa.

### Example 7

The thermoplastic elastomer A-1 was added to dichloromethane, stirred at 60° C. for 30 minutes to be liquefied, and passed through a sintered fiber metal filter having a nominal pore diameter of 10 μm and then passed through a sintered fiber metal filter having the same nominal pore diameter of 10 μm, thereby obtaining a composition C.

A cycloolefin polymer P-1 (manufactured by JSR Corporation, ARTON (registered trademark) F3500) was added to dichloromethane, stirred at 60° C. for 30 minutes to be liquefied, and passed through a sintered fiber metal filter having a nominal pore diameter of 10 μm and then passed through a sintered fiber metal filter having the same nominal pore diameter of 10 μm, thereby obtaining a composition D.

The composition C and the composition D were fed to a casting die equipped with a multi-manifold for co-casting, and cast on a stainless band as a support to produce a base material having a two-layer structure of a layer formed of the composition C and having a thickness of 5 μm (referred to as a first layer in Table 1) and a layer formed of the composition D and having a thickness of 45 μm (referred to as a second layer in Table 1). The stainless band was in contact with the second layer.

The base material was peeled off from the support in the MD direction while applying a 3% draw, and both ends were gripped with a tenter clip and dried at 170° C. for 3 minutes to be stretched by 5% in the TD direction at a stage where the residual solvent amount was 10% by mass by hot air-drying the base material.

A metamaterial and a laminate were produced in the same manner as in Example 1, except that the base material was changed to the base material produced by the above-described method, and the pattern was formed on the surface of the first layer.

In a case where a dielectric loss tangent of the base materials was measured by the same method as in Example 1, it was 0.002.

In a case where a thermal expansion coefficient of the base material was measured by the same method as in Example 1, it was 74 ppm/K.

In a case where an elastic recovery rate of the elastic layer provided in the base material was measured by the same method as in Example 1, it was less than 80%.

In addition, in a case where a storage elastic modulus of the base material and the pattern at 25° C. was measured by the same method as in Example 1, and it was 2.1 GPa and 30 GPa.

### Example 8

As a second layer, a cycloolefin polymer film having a thickness of 100 μm (manufactured by ZEON CORPORATION, ZEONOR (registered trademark) ZF-14, described as PF-1 in Table 1) was prepared. One surface of the second layer was subjected to a corona treatment.

The above-described composition B was applied onto the surface of the second layer, which had been subjected to the corona treatment, using a reverse gravure coater, and a heat treatment was performed in a nitrogen atmosphere at room temperature (25° C.) to 270° C., and the temperature was maintained for 2 hours to form a first layer having a thickness of 10 μm, thereby obtaining a base material.

A metamaterial and a laminate were produced in the same manner as in Example 1, except that the base material was changed to the base material produced by the above-described method.

In a case where a dielectric loss tangent of the base materials was measured by the same method as in Example 1, it was 0.001.

In a case where a thermal expansion coefficient of the base material was measured by the same method as in Example 1, it was 82 ppm/K.

In a case where an elastic recovery rate of the elastic layer provided in the base material was measured by the same method as in Example 1, it was less than 80%.

In addition, in a case where a storage elastic modulus of the base material and the pattern at 25° C. was measured by the same method as in Example 1, and it was 2.1 GPa and 30 GPa.

### Comparative Example 1

A metamaterial and a laminate were produced in the same manner as in Example 1, except that the composition A was used for forming the first layer.

In a case where a dielectric loss tangent of the base materials was measured by the same method as in Example 1, it was 0.003.

In a case where a thermal expansion coefficient of the base material was measured by the same method as in Example 1, it was 42 ppm/K.

In a case where an elastic recovery rate of the elastic layer provided in the base material was measured by the same method as in Example 1, it was more than 80%.

In addition, in a case where a storage elastic modulus of the base material and the pattern at 25° C. was measured by the same method as in Example 1, and it was 1.9 GPa and 30 GPa.

### <<Evaluation of Adhesiveness>>>

The metamaterial before being formed into a laminate with the organic film, which was produced in Examples and Comparative Examples, was cut out into a size including 100 split-ring resonators and used as a test piece.

The above-described test piece was allowed to stand in an environment of 85° C. and a relative humidity of 85% for 72 hours, and then allowed to stand in a humidity-controlled environment.

After the moisture conditioning, the test piece was put into a heat shock tester (manufactured by ESPEC Corp., thermal shock tester TSA series).

The test piece was allowed to stand at −65° C. for 30 minutes, allowed to stand at 125° C. for 30 minutes, and then allowed to stand until the temperature was changed to −65° C. This procedure was considered as one cycle and was repeated for 150 cycles, and then the environment was returned to a temperature of 25° C. and a relative humidity of 55%.

The test piece was observed with an optical microscope and evaluated based on the following evaluation standard. The results are shown in Table 2.

### (Evaluation Standard)

A: in the split-ring resonators, the occurrence of peeling was not observed.
B: in 1 or more and 5 or less of the split-ring resonators, the occurrence of peeling was observed, but there was no problem in practical use.
C: occurrence of peeling was observed in 6 or more of the split-ring resonators.

### <<Evaluation of Crack Suppressibility>>

The metamaterial before being formed into a laminate with the organic film, which was produced in Examples and Comparative Examples, was cut out into a size including 100 split-ring resonators and used as a test piece.

The test piece was put into a heat shock tester (manufactured by ESPEC Corp., thermal shock tester TSA series).

The test piece was allowed to stand at −65° C. for 30 minutes, allowed to stand at 125° C. for 30 minutes, and then allowed to stand until the temperature was changed to −65° C. This procedure was considered as one cycle and was repeated for 150 cycles, and then the environment was returned to a temperature of 25° C. and a relative humidity of 55%.

The test piece was observed with an optical microscope and evaluated based on the following evaluation standard. The results are shown in Table 2.

### (Evaluation Standard)

A: in the split-ring resonators, the occurrence of cracks was not observed.
B: in 1 or more and less than 6 of the split-ring resonators, the occurrence of cracks was observed, but there was no problem in practical use.
C: occurrence of cracks was observed in 6 or more of the split-ring resonators.

TABLE 1

| | First layer (elastic layer) | | | | | Second layer | | | | | | | Third layer | | |
|---|---|---|---|---|---|---|---|---|---|---|---|---|---|---|---|
| | Liquid crystal | | Thermoplastic | | | Liquid crystal | | Cycloolefin | | | | | Liquid crystal | | |
| | polyester | | elastomer | | | polyester | | polymer | | Filler | | | polyester | | |
| | | Content | | Content | Thick- | | Content | | Content | | Content | Thick- | | Content | Thick- |
| | | (part by | | (part by | ness | | (part by | | (part by | | (part by | ness | | (part by | ness |
| | Type | mass) | Type | mass) | (μm) | Type | mass) | Type | mass ) | Type | mass) | (μm) | Type | mass) | (μm) |
| Example 1 | LC-A | 50 | A-1 | 50 | 10 | LC-A | 50 | — | — | F-1 | 50 | 35 | LC-A | 100 | 5 |
| Example 2 | LC-A | 20 | A-1 | 80 | 10 | LC-A | 50 | — | — | F-1 | 50 | 35 | LC-A | 100 | 5 |
| Example 3 | LC-A | 20 | A-1 | 80 | 10 | LC-A | 50 | — | — | F-2 | 50 | 35 | LC-A | 100 | 5 |
| Example 4 | LC-A | 20 | A-1 | 80 | 5 | LC-A | 50 | — | — | F-1 | 50 | 40 | LC-A | 100 | 5 |
| Example 5 | LC-A | 20 | A-1 | 80 | 5 | LC-A | 50 | — | — | F-3 | 50 | 40 | LC-A | 100 | 5 |
| Example 6 | LC-A | 20 | A-2 | 80 | 10 | LC-A | 50 | — | — | F-1 | 50 | 35 | LC-A | 100 | 5 |
| Example 7 | — | — | A-1 | 100 | 5 | — | — | P-1 | 100 | — | — | 45 | — | — | — |
| Example 8 | LC-A | 20 | A-1 | 80 | 10 | — | — | PF-1 | 100 | — | — | 100 | — | — | — |
| Com- | LC-A | 100 | — | — | 10 | LC-A | 50 | — | — | F-1 | 50 | 35 | LC-A | 100 | 5 |
| parative | | | | | | | | | | | | | | | |
| Example 1 | | | | | | | | | | | | | | | |

TABLE 2

| | | | | Ratio of product of | | |
|---|---|---|---|---|---|---|
| | | | | thickness of pattern | | |
| | | | | and storage elastic | | |
| | Base material | | | modulus of pattern | | |
| | | | Elastic | to product of | | |
| | | Thermal | recovery | thickness of base | | |
| | Dielectric | expansion | rate of | material and storage | Evaluation | Evaluation |
| | loss | coefficient | elastic | elastic modulus of | of | of crack |
| | tangent | (ppm/K) | layer (%) | base material | adhesiveness | suppressibility |
| Example 1 | 0.003 | 42 | <80 | 0.09 | B | B |
| Example 2 | 0.002 | 42 | <80 | 0.10 | A | A |
| Example 3 | 0.002 | 43 | <80 | 0.11 | A | A |
| Example 4 | 0.002 | 42 | <80 | 0.09 | A | B |
| Example 5 | 0.002 | 30 | <80 | 0.05 | A | A |
| Example 6 | 0.002 | 42 | <80 | 0.09 | A | A |
| Example 7 | 0.002 | 74 | <80 | 0.14 | A | B |
| Example 8 | 0.001 | 82 | <80 | 0.06 | A | B |
| Comparative | 0.003 | 42 | >80 | 0.08 | C | C |
| Example 1 | | | | | | |

From Table 2, it was found that the adhesiveness between the base material and the pattern and the crack suppressibility in the metamaterial and the laminate obtained in Examples were excellent as compared with the metamaterial and the laminate obtained in Comparative Examples.

The disclosure of JP2022-030213 filed on Feb. 28, 2022 is incorporated in the present specification by reference. All documents, patent applications, and technical standards described in the present specification are incorporated herein by reference to the same extent as in a case of being specifically and individually noted that individual documents, patent applications, and technical standards are incorporated herein by reference.

What is claimed is:

1. A metamaterial comprising:
a base material including at least an elastic layer in which an elastic recovery rate at 25° C. is 80% or less; and
a pattern provided on a surface of the elastic layer,
wherein the pattern is composed of at least one of a conductive material or a material which transits from an insulator to a conductor.

2. The metamaterial according to claim 1,
wherein a thickness of the elastic layer is 7 μm to 15 μm.

3. The metamaterial according to claim 1,
wherein the elastic layer contains a thermoplastic elastomer having a glass transition temperature of −70° C. to 25° C.

4. The metamaterial according to claim 1,
wherein a dielectric loss tangent of the base material is 0.01 or less.

5. The metamaterial according to claim 1,
wherein a thickness of the pattern is less than 5 μm.

6. The metamaterial according to claim 1,
wherein a ratio of a product of a thickness of the pattern and a storage elastic modulus of the pattern at 25° C. to a product of a thickness of the base material and a storage elastic modulus of the base material at 25° C. is less than 10.

7. The metamaterial according to claim 1,
wherein the pattern includes a plurality of structural bodies, and
the structural bodies are a split-ring resonator.

8. The metamaterial according to claim 1,
wherein the pattern is composed of the conductive material, and
the conductive material includes a metal.

9. The metamaterial according to claim 1,
wherein the elastic layer contains at least one selected from the group consisting of a fluorine-based polymer and a liquid crystal polymer.

10. A laminate comprising:
the metamaterial according to a claim 1; and
an organic film provided on a surface of the metamaterial on a pattern side.

11. The laminate according to claim 10,
wherein a moisture permeability of the organic film in an environment of a temperature of 40° C. and a relative humidity of 90% is 3,000 g/(m²·24 hours) or less.

12. The laminate according to claim 10,
wherein the organic film contains an ultraviolet absorber.
